(19) United States
(12) Patent Application Publication
(10) Pub. No.: US 2017/0060991 A1
(43) Pub. Date: Mar. 2, 2017

(54) SYSTEMS AND METHODS FOR GENERATING CONCEPTS FROM A DOCUMENT CORPUS

(71) Applicant: LexisNexis, a division of Reed Elsevier Inc., Miamisburg, OH (US)

(72) Inventors: Paul Zhang, Centerville, OH (US); Sanjay Sharma, Mason, OH (US); David Steiner, Wilmington, OH (US); Mark David Wasson, Seattle, WA (US); Harry R. Silver, Shaker Heights, OH (US); Robin Warling, Tipp City, OH (US)

(73) Assignee: LexisNexis, a division of Reed Elsevier Inc., Miamisburg, OH (US)

(21) Appl. No.: 15/348,333

(22) Filed: Nov. 10, 2016

Related U.S. Application Data
(63) Continuation of application No. PCT/US16/28558, filed on Apr. 21, 2016.
(60) Provisional application No. 62/150,404, filed on Apr. 21, 2015.

(51) Int. Cl. G06F 17/30; G06Q 50/18; G06F 17/22

(52) U.S. Cl. CPC G06F 17/30616; G06F 17/2211; G06Q 50/18; G06F 17/30011

(57) ABSTRACT

Systems and method for generating concepts from a document corpus are disclosed. In one embodiment, a method for generating concepts from a document includes retrieving, a plurality of terms stored within a first lexicon. The method further includes, for individual terms stored within the first lexicon: determining a first frequency of the term within the document corpus, and determining a second frequency of the term within a comparison document corpus including a plurality of comparison documents, wherein the comparison document corpus is different from the document corpus. The method further includes, for individual terms within the first lexicon: determining a difference between the first frequency and the second frequency, comparing the difference between the first frequency and the second frequency to a comparison metric, and, when the difference between the first frequency and the second frequency satisfies the comparison metric, storing the term as a concept within a second lexicon.

### CROSS-REFERENCE TO RELATED APPLICATIONS

This application is a continuation of United States Patent Application PCT Serial No. PCT/US16/28558, entitled “SYSTEMS AND METHODS FOR GENERATING CONCEPTS FROM A DOCUMENT CORPUS”, and filed on Apr. 21, 2016, which claims the benefit of priority from U.S. Provisional Application No. 62/150,404, entitled “SYSTEMS AND METHODS FOR CONCEPT GENERATION AND USAGE,” filed Apr. 21, 2015, the disclosures of which are expressly incorporated herein by reference in their respective entireties.

### BACKGROUND

Field

Embodiments provided herein generally relate to increasing search functionality and efficiency for document searching, document indexing, and other tasks by extracting concepts discussed within a document corpus, and more particularly, to generating concepts from a larger lexicon extracted from the document corpus to increase accuracy of user-performed functions.

Technical Background

As electronic systems convert documents and other data into electronic form, many of documents that have been converted are indexed to facilitate search, retrieval, and/or other functions. For example, legal documents of a document corpus, such as court decisions, briefs, motions, and the like may be stored and indexed for users to access electronically. As different legal documents may include different legal points pertaining to different jurisdictions, those documents may be indexed and organized accordingly.

Many, many concepts may be discussed within the document corpus. Depending on the general subject matter of the document corpus (e.g., legal, scientific, medical, and the like), there may be a subset of concepts that are of significant importance within the document corpus. Uncovering these important concepts may improve computerized document indexing, document searching, and other functionalities, for example.

Accordingly, a need exists for systems and methods for extracting important concepts from a document corpus.

### SUMMARY

In one embodiment, a computer implemented method for generating concepts from a document corpus including a plurality of documents includes retrieving, using a processing device, a plurality of terms stored within a first lexicon. The method further includes, for individual terms of the plurality of terms stored within the first lexicon: determining, using the processing device, a first frequency of the term within the document corpus, and determining, using the processing device, a second frequency of the term within a comparison document corpus including a plurality of comparison documents, wherein the comparison document corpus is different from the document corpus. The method further includes, for individual terms of the plurality of terms stored in the first lexicon: determining, using the processing device, a difference between the first frequency and the second frequency, comparing, using the at least one processing device, the difference between the first frequency and the second frequency to a comparison metric, and, when the difference between the first frequency and the second frequency satisfies the comparison metric, storing the term as a concept within a second lexicon stored in a non-transitory computer readable medium.

In another embodiment, a system for generating concepts from a document corpus including a plurality of documents includes at least one processing device, and at least one non-transitory computer-readable medium storing computer readable instructions that, when executed by the at least one processing device, causes the at least one processing device to retrieve a plurality of terms within a first lexicon stored in the at least one non-transitory computer-readable medium. The computer readable instructions further cause the at least one processing device to, for individual terms of the plurality of terms stored within the first lexicon: determine a first frequency of the term within the document corpus, determine a second frequency of the term within a comparison document corpus including a plurality of comparison documents, wherein the comparison document corpus is different from the document corpus, determine a difference between the first frequency and the second frequency, compare the difference between the first frequency and the second frequency to a comparison metric, and when the difference between the first frequency and the second frequency satisfies the comparison metric, store the term as a concept within a second lexicon stored in the at least one non-transitory computer-readable medium.

In yet another embodiment, a computer implemented method for generating concepts from a document corpus including a plurality of documents includes retrieving, using a processing device, a plurality of terms stored within a first lexicon. The method further includes, for individual terms of the plurality of terms stored within the first lexicon: determining, using the processing device, a subset of the plurality of documents, where each document with the subset of the plurality of documents has a body section that includes the term, determining, using the processing device, a percentage of documents within the subset of the plurality of documents that has a headnotes section that includes the term, comparing the percentage with a percentage threshold, and, when the percentage is greater than the percentage threshold, storing the term as a concept within a second lexicon stored in a non-transitory computer readable medium.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a computing network illustrating components for a system for concept generation, according to one or more embodiments shown and described herein;

FIG. 2 depicts the computing device for concept generation from FIG. 1, further illustrating hardware and software that may be utilized in generating a lexicon and concepts from that lexicon, according to one or more embodiments show and described herein;

FIG. 3 depicts a flowchart illustrating an example process for generating a second lexicon storing a plurality of important, high-level concepts from a larger first lexicon extracted from a document corpus according to one or more embodiments described and illustrated herein;

FIG. 4 depicts a flowchart illustrating another example process for generating a second lexicon storing a plurality of important, high-level concepts from a larger first lexicon extracted from a document corpus according to one or more embodiments described and illustrated herein;

FIG. 5 depicts a flowchart illustrating an example process that may be utilized for generating a first lexicon, according to one or more embodiments shown and described herein;

FIG. 6 depicts an example process that may be utilized for generating initial terms from the document corpus, according to one or more embodiments shown and described herein;

FIG. 7 depicts an example process that may be utilized for generating equivalency grouping of terms for the lexicon, according to one or more embodiments shown and described herein; and

FIGS. 8 and 9 depict an example graphical user interface illustrating links between concepts and documents within a document corpus according to one or more embodiments shown and described herein.

### DETAILED DESCRIPTION

Embodiments of the present disclosure are directed to systems and methods for generating high-level concepts appearing in a document corpus. As an example and not a limitation, such important, high-level concepts may be legal concepts that appear in a legal document corpus. In embodiments, a small set of high-level concepts are determined from a larger set of terms extracted from the document corpus.

As described in more detail below, the important, high-level concepts may be generated from a lexicon (i.e., a dictionary) of terms extracted from the documents of the document corpus. As such, the high-level concepts represent a subset of a larger number of terms found in the lexicon. Embodiments described herein determine those terms within the lexicon of the document corpus having a high-importance with respect to the specific document corpus, and select these terms as high-level concepts. As a non-limiting example, the term “insufficient evidence” may be found in a lexicon generated from a legal document corpus, and it may be determined to have a higher-importance within the legal document corpus as compared to other terms. As such, the term “insufficient evidence” may be stored in a second lexicon as a high-level concept.

Although embodiments described herein describe the document corpus as a legal document corpus in several examples, it should be understood that embodiments are not limited thereto. As further non-limiting examples, the document corpus may be a scientific journal document corpus, a medical journal document corpus, a culinary document corpus, or the like.

The high-level concepts extracted from the document corpus may be classified into various classifications depending on the subject matter of the document corpus. As a non-limiting example, in the legal context, the concepts extracted from the document corpus may classified as, without limitation, a legal principal, a procedural concept, or a fact-based concept.

These high-level concepts, once extracted, may then be utilized to improve functions such as document indexing, searching, networking, and the like. Further, linguistic variations of the important, high-level concepts may be determined, stored, and utilized.

Embodiments provided herein also disclose methods for generating a lexicon (i.e., dictionary) based on contents from the document corpus that contains groups of semantically equivalent terms comprised of variations of phrases and single words associated with a normalized form for that group.

Various embodiments for generating concepts from a document corpus are described herein below.

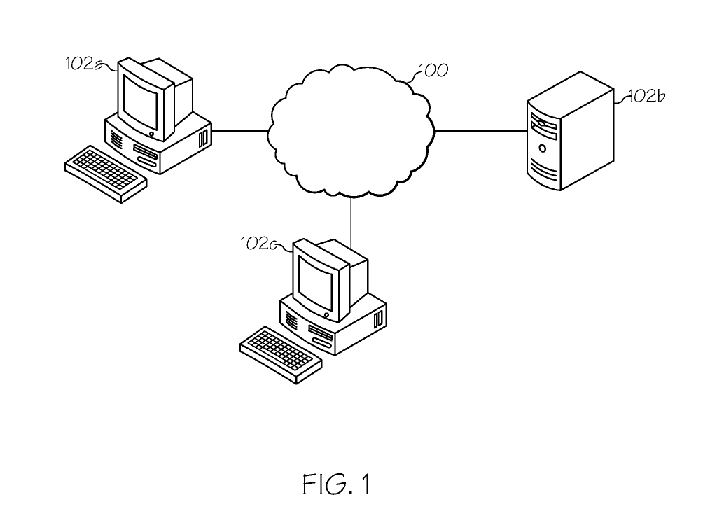

Referring now to the drawings, FIG. 1 depicts an exemplary computing network, illustrating components for a system generating concepts from a document corpus, according to one or more embodiments shown and described herein. As illustrated in FIG. 1, a computer network 100 may include a wide area network, such as the internet, a local area network (LAN), a mobile communications network, a public service telephone network (PSTN) and/or other network and may be configured to electronically connect a user computing device 102a, a concept generation computing device 102b, and an administrator computing device 102c.

The user computing device 102a may initiate an electronic search for one or more documents. More specifically, to perform an electronic search, the user computing device 102a may send a request (such as a hypertext transfer protocol (HTTP) request) to the concept generation computing device 102b (or other computer device) to provide a data for presenting an electronic search capability that includes providing a user interface to the user computing device 102. The user interface may be configured to receive a search request from the user and to initiate the search. The search request may include terms and/or other data for retrieving a document.

Additionally, included in FIG. 1 is the administrator computing device 102c. In the event that the concept generation computing device 102b requires oversight, updating, or correction, the administrator computing device 102c may be configured to provide the desired oversight, updating, and/or correction.

It should be understood that while the user computing device 102a and the administrator computing device 102c are depicted as personal computers and the concept generation computing device 102b is depicted as a server, these are merely examples. More specifically, in some embodiments any type of computing device (e.g., mobile computing device, personal computer, server, and the like) may be utilized for any of these components. Additionally, while each of these computing devices is illustrated in FIG. 1 as a single piece of hardware, this is also an example. More specifically, each of the user computing device 102a, concept generation computing device 102b, and administrator computing device 102c may represent a plurality of computers, servers, databases, and the like.

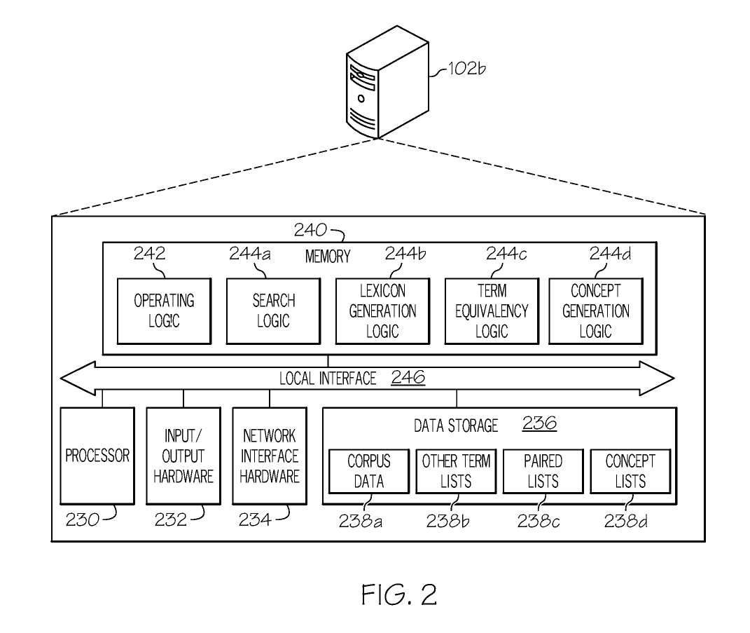

FIG. 2 depicts the concept generation computing device 102b, from FIG. 1, further illustrating a system for generating concepts and first and second lexicons and/or a non-transitory computer-readable medium for generating concepts and first and second lexicons embodied as hardware, software, and/or firmware, according to embodiments shown and described herein. While in some embodiments, the concept generation computing device 102b may be configured as a general purpose computer with the requisite hardware, software, and/or firmware, in some embodiments, the concept generation computing device 102b may be configured as a special purpose computer designed specifically for performing the functionality described herein.

As also illustrated in FIG. 2, the concept generation computing device 102b may include a processing device 230, input/output hardware 232, network interface hardware 234, a data storage component 236 (which stores corpus data 238a, other term lists 238b, paired lists 238c, and concept lists 238d), and a memory component 240. The memory component 240 may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components. Additionally, the memory component 240 may be configured to store operating logic 242, search logic 244a, lexicon generation logic 244b, term equivalency generation logic 244c, and concept generation logic 244d (each of which may be embodied as a computer program, firmware, or hardware, as an example). A local interface 246 is also included in FIG. 2 and may be implemented as a bus or other interface to facilitate communication among the components of the concept generation computing device 102b.

The processing device 230 may include any processing component(s) configured to receive and execute instructions (such as from the data storage component 236 and/or memory component 240). The input/output hardware 232 may include a monitor, keyboard, mouse, printer, camera, microphone, speaker, and/or other device for receiving, sending, and/or presenting data. The network interface hardware 234 may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component 236 may reside local to and/or remote from the concept generation computing device 102b and may be configured to store one or more pieces of data for access by the concept generation computing device 102b and/or other components. As illustrated in FIG. 2, the data storage component 236 stores corpus data 238a, which in a non-limiting example, includes legal and/or other documents that have been organized and indexed for searching. The legal documents may include case decisions, briefs, forms, treatises, and the like. Similarly, other term lists 238b may be stored by the data storage component 236 and may include one or more lists to be used by the lexicon generation logic 244b, the term equivalency generation logic 244c, and the concept generation logic 244d. Paired lists 238c may also be stored by the data storage component 236 and may include data related to a normalized term and the associated candidate terms (and/or equivalents). Concepts lists 238d stored by the data storage component 236 may represent the second lexicon and associated concepts as described in more detail below.

Included in the memory component 240 are the operating logic 242, the search logic 244a, the lexicon generation logic 244b, the term equivalency generation logic 244c, and the concept generation logic 244d. The operating logic 242 may include an operating system and/or other software for managing components of the concept generation computing device 102b. Similarly, the search logic 244a may reside in the memory component 240 and may be configured to facilitate electronic searches, such as by the user computing device 102a (FIG. 1). The search logic 244a may be configured to compile and/or organize documents and other data such that the electronic search may be more easily performed for the user computing device 102a. The search logic 244a may also be configured to provide data for a user interface to the user computing device 102a, receive a search request, retrieve the associated documents, and provide access to those documents to the user computing device 102a.

As is also illustrated in FIG. 2, the lexicon generation logic 244b may reside in the memory component 240. As described in more detail below, the lexicon generation logic 244b may be configured to locate corpus terms (phrases and single words) from the corpus data 238a, and determine candidate terms to use based on frequency of usage found in the corpus data 238a. Further, the term equivalency generation logic 244c may be configured to generate term equivalents, based on candidate terms determined in the previous portion of the sequence by lexicon generation logic 244b, as described in more detail below. As described in more detail below, the concept generation logic 244d may be configured to generate high-level concepts from the lexicon generated by the lexicon generation logic 244b. While the search logic 244a, the lexicon generation logic 244b, and the term equivalency generation logic 244c are illustrated as different components, this is merely an example. More specifically, in some embodiments, the functionality described herein for any of these components may be combined into a single component.

It should also be understood that the components illustrated in FIG. 2 are merely exemplary and are not intended to limit the scope of this disclosure. More specifically, while the components in FIG. 2 are illustrated as residing within the concept generation computing device 102b, this is merely an example. In some embodiments, one or more of the components may reside external to the concept generation computing device 102b. Similarly, while FIG. 2 is directed to the concept generation computing device 102b, other components such as the user computing device 102a and the administrator computing device 102c may include similar hardware, software, and/or firmware.

Generation of important, high-level concepts from a first lexicon (e.g., a dictionary) of terms extracted from a document corpus will now be described. As used herein, the terms “concept” and important, high-level concept” are used interchangeably, and mean a word or phrase that satisfies an objective metric. In some embodiments, important, high-level concepts satisfy predetermined heuristic rules in addition to satisfying the objective metric.

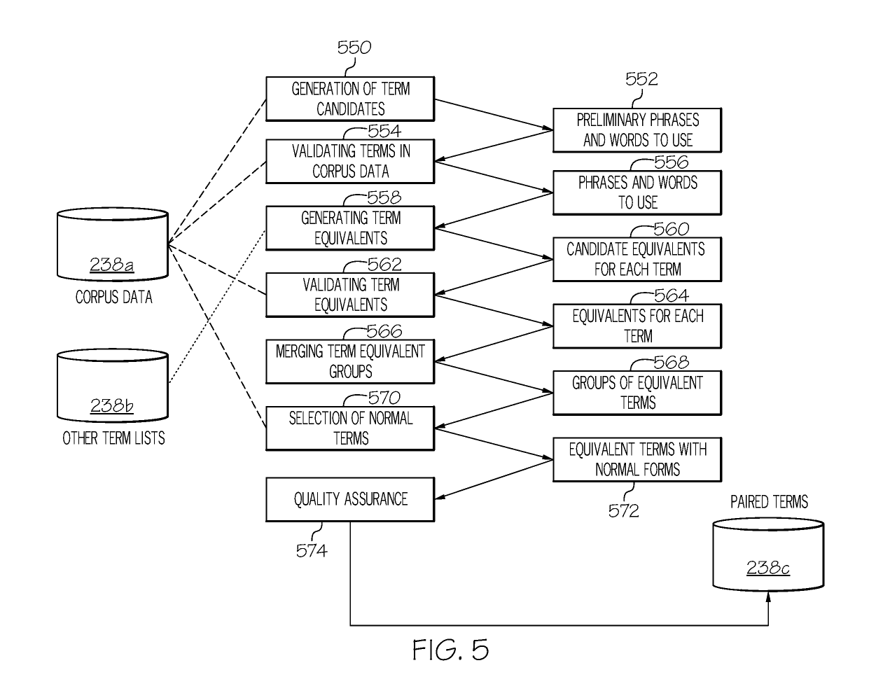

Any means may be utilized to generate a first lexicon from which the important, high-level concepts are generated. In one example, the lexicon is provided as a dictionary of terms. In another example, the lexicon is generated according the embodiments described with respect to FIGS. 5-7 below. The first lexicon may contain any number of individual terms. In one non-limiting example, the first lexicon includes hundreds of thousands of individual terms.

Embodiments described herein extract individual terms of high importance within the document corpus from the first lexicon. From this large first lexicon, a smaller set of important, high-level concepts are determined. These high-level concepts may have a particular significance within the document corpus. In a legal document corpus, for example, particular legal terms may be a greater importance than non-legal terms within the legal document context. The high-level concepts may be important legal concepts that appear frequently within the document corpus.

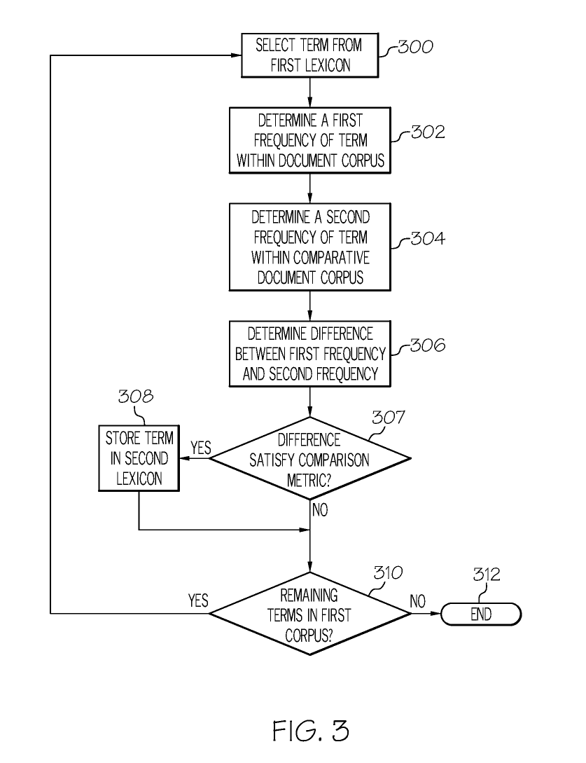

Referring now to FIG. 3, one example method of extracting important, high-level concepts (i.e., “concepts”) from a large first lexicon is graphically illustrated in a flowchart. At block 300, a term from a first lexicon is selected for evaluation. As noted hereinabove, the first lexicon, which may comprise a plurality of normalized terms, may be generated by any means. At block 302, a frequency of the selected term within the document corpus is determined using the processing device (i.e., a first frequency). As an example and not a limitation, the process may determine the total number of individual documents that include the selected term. The frequency may be determined by dividing the number of individual documents including the selected term by the total number of documents within the document corpus. As another example, a frequency of the selected term may be generated and represented by a term frequency-inverse document frequency (tf-idf). Other methods of calculating a frequency of the selected term may be utilized.

Next, at block 304, a frequency of the selected term within a comparative document corpus is determined (i.e., a second frequency). The comparative document corpus is different from the document corpus. The comparative document corpus may represent general usage of terms and provide a baseline for determining whether or not the terms within the first lexicon are of particular importance in the document corpus. The comparative document corpus should be based on a topic that is different than the document corpus. Ideally, the comparative document corpus should cover a vast array of different topics. In one non-limiting example, the comparative document corpus is a news article corpus comprising a plurality of news articles. As news articles generally cover a vast array of topics, a news article corpus may provide a good representation of terms as used by the general population.

The frequency of the selected term within the comparative document corpus may be determined at block 304 in a manner similar to that described above with respect to block 302.

At block 306, the difference between the first frequency and the second frequency is determined. The second frequency may be subtracted from the first frequency. At block 307, the difference between the first frequency and the second frequency is compared to a comparison metric. If the difference satisfies the comparison metric, then the process moves to block 308. If it does not, the process moves to block 310.

As an example, the comparison metric is a threshold value. When the difference determined at block 306 is greater than (or greater than or equal to) the threshold value, the process moves to block 308 where the selected term is stored within a second lexicon as a candidate important, high-level concept. Appearance in the document corpus more frequently than in the comparative document corpus is indicative of the selected term's importance within the document corpus. After the selected term is stored in the second lexicon at block 308, the process moves to block 310.

When the difference is less than the threshold value, it may be deemed that the selected term does not possess the requisite importance within the document corpus, and the process moves to block 310 such that the selected term is not stored as an important, high-level concept.

The threshold value may be selected heuristically, for example. Any threshold value may be utilized. As an example and not a limitation, the threshold value may be twenty such that when the selected term appears in the document corpus at least twenty percent more in the document corpus than in the comparative document corpus, the selected term is stored as a candidate important, high-level concept in a second lexicon at block 308.

At block 310, it is determined whether or not there are remaining terms within the first lexicon that have not yet been evaluated. If there are remaining terms within the first lexicon, the process moves back to block 300, wherein the next term is evaluated. If there are no more remaining terms in the first lexicon, the process moves to block 312 and ends. As an example and not a limitation, each term within the first lexicon may be evaluated sequentially, e.g., in alphabetical order or in some other predetermined order. It should be understood that not all terms within the first lexicon may be evaluated. For example, a subset of the terms within the first lexicon may be evaluated in some embodiments.

Once all of the selected terms are evaluated, a second lexicon storing a plurality of concepts that are of particular importance within the document corpus may be generated. In some embodiments, all terms satisfying the comparison metric at block 307 of FIG. 3 are saved in the second lexicon at block 308. In other embodiments, terms satisfying the comparison metric at block 307 may be further analyzed to determine if the terms should be saved as concepts within the second lexicon. For example, heuristic rules may be applied to determine whether or not a term satisfying the comparison metric should be saved as a concept. As a non-limiting example, the candidate important, high-level concept may be compared against a list of words and, if the particular candidate important, high-level concept includes that word, it is saved as an important, high-level concept in the second lexicon. As a further non-limiting legal example, terms such as “claim,” “action,” “act,” “suit,” “lawsuit,” and the like may be included in such a list of words such that any candidate important, high-level concept including one of these words is saved as a concept in the second lexicon. As another example, a list of words may be provided such that any candidate, important high-level concept including a word within the list of words is not saved as a concept in the second lexicon. Other types of heuristic rules may be applied depending on the particular application. More than one type of heuristic rule may be applied to candidate important, high-level concepts in some embodiments.

As described in more detail below, the second lexicon may be utilized to improve the computing performance of one or more computers performing functions such as document indexing and searching.

In some embodiments, at least one additional comparative document corpus may also be evaluated to generate at least one additional frequency. Any number of additional comparative document corpuses may be evaluated to generate any number of additional frequencies. An average frequency of the second frequency and the at least one additional frequency may be determined. Then, at block 306, the first frequency may be compared with the average frequency.

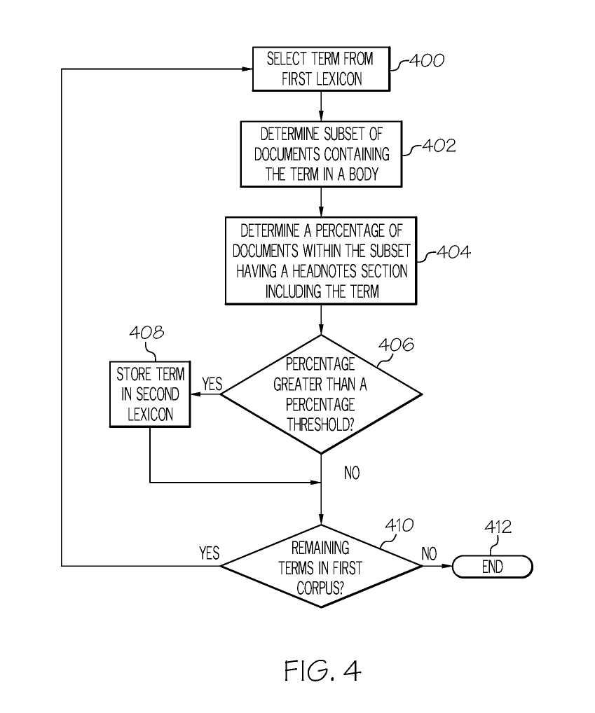

Referring now to FIG. 4, another example of a method of extracting high-level concepts from a large first lexicon is graphically illustrated in a flowchart. At block 400, a term from a first lexicon is selected for evaluation. Documents within the particular document corpus from which the first lexicon is generated include a body section and a headnotes section. As an example and not a limitation, the body section may be a legal opinion as originally published by a court. As used herein, a headnotes section means any section of a document providing a summary of the underlying document as originally published. As an example and not a limitation, the headnotes section may include various summaries of points of law discussed within a legal opinion. The headnotes section may be added by an editor, for example. As headnotes sections typically summarize points that are important in the underlying body section of the document, terms appearing within the headnotes section may be of particular importance.

At block 402, a subset of documents within the document corpus that include the selected term within a body section of the document is determined by the one or more processing devices. Accordingly, each document within the subset of documents includes the selected term. At block 404, it is determined which documents within the subset of documents also includes the selected term within a headnotes section. Further at block 404, a percentage of documents within the subset that have the selected term present within the headnotes section is determined. Terms of the first lexicon appearing frequently within a headnotes section may have a particular importance within the document corpus. Conversely, terms within the first lexicon that do not appear frequently within a headnotes section may not have particular importance. As an example and not a limitation, a term appearing in a headnotes section in seventy-five percent of documents within the subset of documents may have particular importance. Conversely, term appearing in a headnotes section in only ten percent of documents in the subset may not have importance.

It is noted that, in an alternative embodiment, the percentage calculated at block 404 is the percentage of documents within the document corpus that the selected term appears within a headnotes section. In other words, a subset of documents including the selected term is not determined (i.e., block 402 is not performed). Rather, the percentage is based on the number of documents that the selected term appears within a headnotes section.

At block 406, the percentage calculated at block 404 is compared against a percentage threshold. If the percentage calculated at block 404 is greater than the percentage threshold, the selected term may be stored as an important, high-level concept in a second lexicon at block 408. The process then moves to block 410. If the percentage calculated at block 404 is not greater than the percentage threshold, the process moves to block 410 and the selected term is not saved within the second lexicon.

At block 410, it is determined whether or not there are remaining terms within the first lexicon that have not yet been evaluated. If there are remaining terms within the first lexicon, the process moves back to block 400, wherein the next term is evaluated. If there are no more remaining terms in the first lexicon, the process moves to block 412 and ends. As an example and not a limitation, each term within the first lexicon may be evaluated sequentially, e.g., in alphabetical order or in some other predetermined order. It should be understood that not all terms within the first lexicon may be evaluated. For example, a subset of the terms within the first lexicon may be evaluated in some embodiments.

As described hereinabove, with respect to FIG. 3, in some embodiment, the candidate important, high-level concepts satisfying the threshold may be automatically saved in the second lexicon at block 408. In other embodiments, one or more heuristic rules may be applied to the candidate important, high-level concepts to determine whether or not to save them in the second lexicon, as described above.

Accordingly, the set of high-level concepts stored within the second lexicon may be generated through data-mining from a document corpus to capture the major points of discussion within the documents of the document corpus. In some embodiments, the number of individual terms stored within the second lexicon may be limited to provide for a more manageable list, depending on the intended use of the second lexicon. As an example and not a limitation, the processes described above and illustrated in FIGS. 3 and 4 may be run iteratively and by adjusting the various threshold value(s) until a desired number of terms are stored within the second lexicon.

The processes of determining the concepts may be performed at desired time intervals (e.g., once a week, once a month, four times a year, etc.) to capture new and evolving concepts within the document corpus. As an example and not a limitation, the term “child online protection” was not present in any legal case until 1999, when there was only one reported case. Now, however, this term has become much more frequent in legal opinions.

In some embodiments, the high-level concepts listed within the second may be further classified by a concept type. As a non-limiting example, in the legal context, three different types of concepts may be utilized: (1) Legal Principles (e.g., single satisfaction rule (one satisfaction rule), doctor patient privilege, intentional acts exclusion, and last clear chance); (2) Procedural-based Concepts (e.g., dismiss with/without prejudice, revocation of probation, grant of a summary judgment), and (3) Fact-based Concepts (e.g., DUI (DWI, driving with blood alcohol, driving a vehicle under the influence, . . . ), dog bite (bites from a dog, dogs attacked and bit, bitten by a dog, . . . ), child abandonment (abandoning a minor, abandonment of children, . . . ), passenger injury (injured passenger, injuries to passenger, passenger's injury, . . . ). It should be understood that more or fewer concept types may be utilized.

It is noted that, in some cases, concepts may not always fall clearly into one of the concept classifications. In some embodiments, rules may be defined to assist in assigning concepts to the proper concept classification. Potential means or sources for selecting legal concepts for inclusion into a concept type include, but are not limited to, taxonomy topics, legal dictionary entries, user queries, and custom dictionaries.

In some embodiments, one or more of the generated concepts may be expanded to include varied forms. The concepts may be expanded by an algorithm automatically, for example. As an example and not a limitation, the terms defining the concepts may be expanded by the following linguistics-based rules in a programmatic process:
Inflection variations, e.g., liability=liabilities, begin=beginning
One form of derivational variation, -tion, e.g., satisfy=satisfaction (but not probate vs. probation)
Portmanteau terms, e.g., pre-arrange=prearrange
Controlled linguistic structures within phrases, e.g., motion for new trial=new trial motion
. . .

Expansion rules may be combined to produce a desired result of expanded terms/concepts. Non-limiting examples of expanded terms/concepts include:
passerby=passerbys=passersby=passers by=passer by
abuse of discretion=abused its discretion= . . .
right of woman=women right=women's rights

Additional information regarding term expansion is provided below with respect to generation of the first lexicon.

Structurally different phrases may also be grouped together based on key terms within the phrases and stored in the second lexicon or separate storage location. As an example and not a limitation, programmatic means may be used to generate a list of phrases that share one or more words. The empirical selection for grouping phrases may be based on categories. As an example and not a limitation, these categories may include, but are not limited to, expansion based on structures that are known to equate terms (e.g., absence of negligence, lack of negligence, non negligence, want of negligence, without any negligence, and the like), derivational changes that are known to not produce undesirable results (e.g., obese=obesity, inadmissibility=inadmissible; but not government vs. govern, constitute vs. constitution, abort vs. abortion), and synonyms and other related terms that are known not to produce undesirable results. When expanding terms, it should be questioned whether or not expanding the term will produce in undesirable results.

As noted hereinabove, the larger first lexicon (i.e., dictionary) may be generated in any number of ways. FIG. 5 depicts a flowchart illustrating one example process that may be utilized for implementing lexicon generation to create a large first lexicon from a document corpus, according to embodiments shown and described herein. As illustrated, in FIG. 5, the lexicon generation logic 244b may generate term candidates for lexicon generation (block 550). More specifically, the corpus data 238a may include a listing of corpus terms that may be used in a future search. The lexicon generation logic 244b (via the processing device 230) can retrieve the corpus terms from the corpus data 238a and generate candidate terms associated with those corpus terms. As an example, if the corpus term “insufficient evidence” is located in the corpus data 238a, the lexicon generation logic 244b, based on its linguistic and contextual clues, the term becomes a potential candidate term for the next portion of the process.

It should be understood that generation of the candidate terms may include one or more techniques for determining variants of the corpus terms. As an example, the lexicon generation logic 244b may be configured to access the data storage component 236 to identify different forms of terms in the corpus (e.g., plural form, different conjugations, and the like.). From this determination, the lexicon generation logic 244b may identify preliminary phrases and words to use as candidate terms (block 552).

Once the candidate terms are generated, the candidate terms can be validated in the corpus data 238a (block 554). More specifically, the candidate terms may be searched against the corpus data 238a, (e.g., with a finite state machine), and the result may be calculated to create a document frequency file. The document frequency file may be compared with a predetermined threshold of occurrences (e.g., 0, 1, 2, 3, etc.) and terms that are found in documents fewer than or equal to the threshold will be removed. Once the candidates are validated, the phrases and words used in the processing are solidified (block 556).

Additionally, term equivalents may be generated by the term equivalency generation logic 244c (block 558). More specifically, potential equivalent terms for each term in block 556 may be programmatically generated by the term equivalency generation logic 244c assisted by rules specified in the term equivalency generation logic 244c and the supplemental information provided in other term lists 238b. As an example, the other term lists 238b may be used as a supplement of information to the process of block 558 and may include rules encoded that may not be handled otherwise. Such rules may be configured to understand that the plural form of the term “child” is “children”, where utilizing the normal plural form for words (e.g., adding an ‘s’ or ‘es’) would be inapplicable. As a result, generation of the term equivalents may provide candidate equivalent terms (block 560). In the example given above, where “insufficient evidence” is identified from the corpus data 238a, the lexicon generation logic 244b in block 558 can generate its equivalent terms such as “insufficient evidences,” “insufficiency of the evidence,” “insufficiency of evidences,” etc. These equivalent terms are stored in block 560 as candidate equivalents waiting for validation.

Similarly, validation of the candidate equivalents (block 562) is based on usage frequencies, and yields equivalent term list (block 564). The pairs of equivalent terms can then be merged and/or linked (block 566) based on rules specified in term equivalency generation logic 244c to form equivalent term groups. The merging may simply include combining the two pieces of data and/or removing duplicates to create the groups of equivalent terms (block 568). However, in some embodiments, equivalent pairs of terms may be collected and a determination can be made regarding whether the equivalent pairs are also equivalent. If so, these equivalent pairs may be merged together into a group of equivalent terms.

Additionally, normalized terms may be selected from the consolidated groups of terms (block 570), discussed above. More specifically, for each group of terms a determination may be made using heuristic rules (such as frequency, noun plurality, and the like) to determine which of the terms to designate as the normalized term. Referring to the example above, a group of terms may be found in documents located in the corpus data 238a according to the following:

TABLE 1

| TERM | FREQUENCY |
|---|---|
| Insufficient evidence | 17268 |
| Insufficiency of the evidence | 6927 |
| Insufficiency of evidence | 2969 |
| Evidence insufficient | 809 |
| Evidentiary insufficiency | 154 |

As illustrated in Table 1, the term “insufficient evidence” occurs more frequently in documents located in the corpus data 238a than the other terms in this group. Additionally, as “insufficient evidence” is the simplest term in the group, “insufficient evidence” may be selected as the normalized term for the group. Accordingly, lexicon matched terms that include equivalent terms with normalized forms may be identified (block 572). A quality assurance check may be performed (automatically and/or manually) at block 574. After quality assurance, the lexicon matched terms may be stored in the paired lists 238c. Once lexicon matched terms are stored, a user-designated search may be performed utilizing the lexicon matched terms.

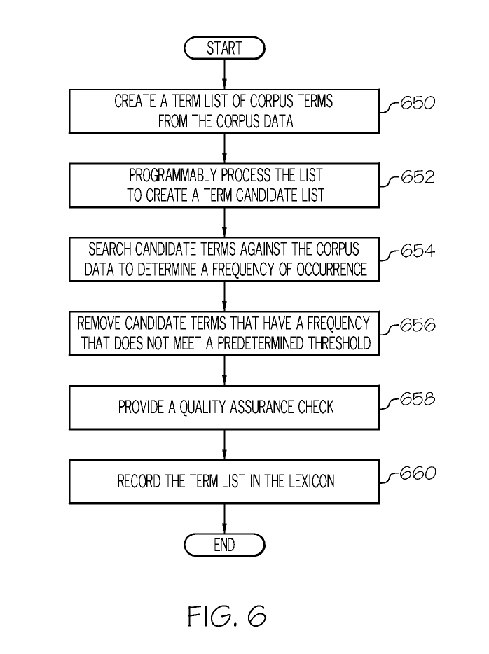

FIG. 6 depicts a process that may be utilized for generating initial terms from the corpus, such as may be performed through use of the lexicon generation logic 244b, according to embodiments shown and described herein. As illustrated in FIG. 4, a term list of corpus terms from the corpus data 238a can be created (block 650). The list may additionally be programmably processed to create a term candidate list (block 652). The candidate terms may be searched against the corpus data to determine a frequency of occurrence in documents that are provided in the corpus data 238a (block 654). The candidate terms that have a frequency that does not meet a predetermined threshold can be removed (block 656). Additionally, a quality assurance check may be performed (block 658). Additionally, the term list can be recorded in the lexicon (block 660).

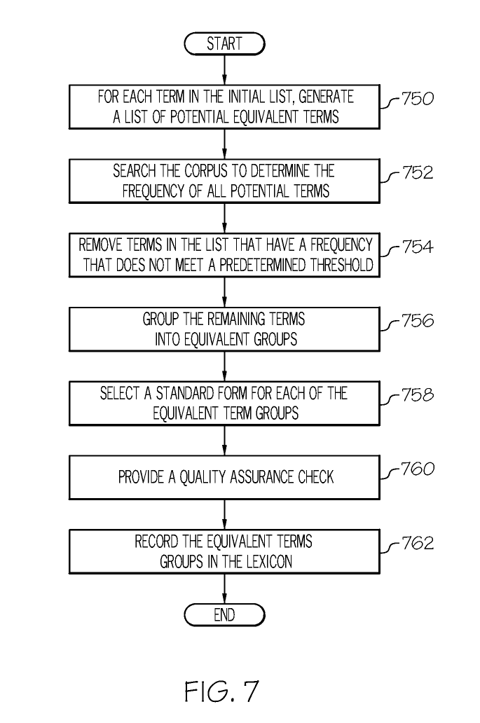

FIG. 7 depicts a process that may be utilized for generating equivalency grouping of terms for the lexicon, such as may be performed through use of the term equivalency generation logic 244c, according to embodiments shown and described herein. As illustrated in FIG. 5, a list of potential equivalent terms may be generated for each term in the initial list (block 750). The corpus may then be searched to determine the frequency of all potential terms (block 752). Candidate terms that have a frequency of occurrence that does not meet a predetermined threshold may be removed (block 754). The remaining terms may be grouped into equivalent terms (block 756). A standard form for each of the equivalent term groups may be selected (block 758). Further, a quality assurance check may be performed (block 760). The equivalent term groups may then be recorded in the lexicon (block 762).

The smaller second lexicon of important, high-level concepts described above may be used to enhance the functionality of computing systems for indexing and searching for documents. Once these concepts and their linguistic and semantic variations have been stored, the texts of the documents within the document corpus may be annotated with a normalized form of the concept. For example, phrases such as “without a search warrant,” “searched without a warrant,” “absence of a search warrant” and many other phrases deemed as linguistic variants by the above process may all be stored in the second lexicon under the normalized concept “warrantless search.” Every instance of one of these phrases may be annotated (e.g., using an annotation protocol, such as XML) with the normalized concept “warrantless search.”

When a query is submitted, the search engine may determine whether or not a concept stored in the second lexicon is present within the query. For example, if a concept is present within the search query, either in the normalized form or in a stored variation, the metadata of the documents may be searched for the normalized form of the concept to retrieve documents that discuss this concept. Accuracy and efficiency is therefore improved because matching is done at a normalized level. The use of the generated normalized concepts enables documents to be found that would not have been otherwise found due to differences in terms.

Additionally, for each document, a number of concepts as defined by the second lexicon may be determined. Those concepts within the document that are discussed the most thoroughly (e.g., have the most text attributed to them) may be designated as a key concept. These key concepts may be presented to the user when a document is displayed in a graphic user interface, for example.

In some embodiments, each concept stored within the second lexicon has a unique identification number. As noted above, the concepts are searchable. Even further, concept linking may also be provided. For example, concepts that more frequently appear within document contemporaneously may be linked together within the second lexicon or other storage means.

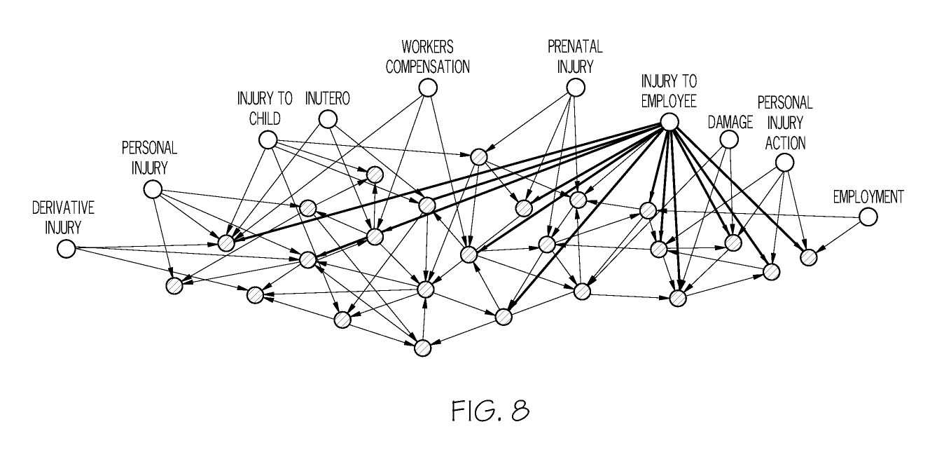

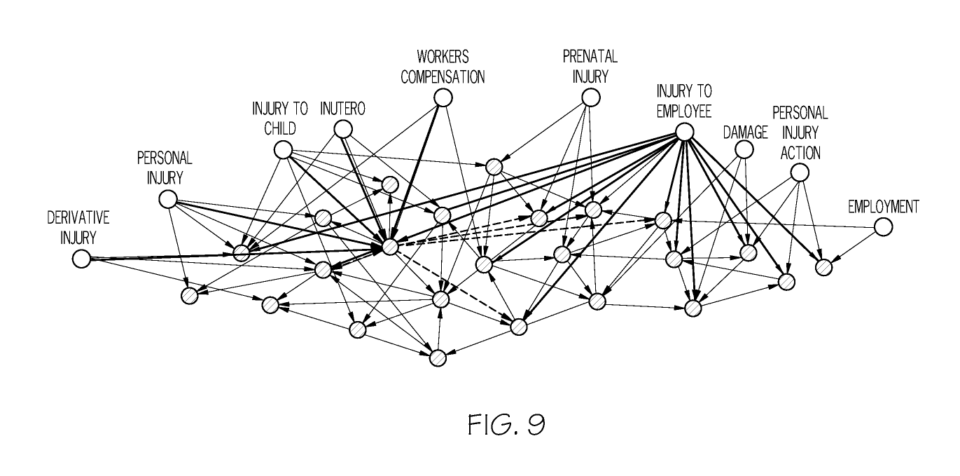

The concepts stored within the second lexicon may also be utilized to generate various graphical user interfaces to illustrate how concepts and documents are linked together in a network. FIGS. 8 and 9 illustrate a legal citation network example wherein the light circles around the periphery represent concepts and the dark circles represent legal cases. The edges between the circles illustrate how the various concepts and legal cases are linked together. The edges between legal cases represent citation links. The edges between concepts and legal cases illustrate that a particular case discusses the particular issues. It should be understood that FIGS. 8 and 9 are provided for illustrative purposes only, and that embodiments are not limited by the graphical interfaces illustrated by FIGS. 8 and 9.

In one example, a user may present a search request regarding a particular concept. As a non-limiting example, the user's selected concept may be “injury to employee.” The document corpus may be searched for legal cases that discuss the selected concept (e.g., “injury to employee”). Further, based on the links between the various concepts stored within the second lexicon, a plurality of similar concepts that appear frequently in legal cases along with the selected concept may be returned and displayed. In FIG. 8, these concepts appear as the light circles.

Also returned are a plurality of legal cases that discuss the selected concept, such as the concept “injury to employee,” as well as legal cases that discuss the similar concepts that were returned by the search. In the illustrated example, as shown in FIG. 8, when a user selects a concept, the edges presenting a link between the concept and a legal case are highlighted. In this manner, the user may easily identify which cases discuss the concept that he or she selects in the graphical user interface. Similarly, as shown in FIG. 9, a user may select an individual case within the graphical user interface, which causes edges between individual cases representing citation links to be highlighted, as well as edges out to concepts that are discussed by the legal case currently selected by the user within the graphical user interface. It should be understood that graphical user interfaces and functionality may be enabled from the concepts stored in the second lexicon.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A computer implemented method for generating concepts from a document corpus comprising a plurality of documents, the method comprising:
retrieving, using a processing device, a plurality of terms stored within a first lexicon; and
for individual terms of the plurality of terms stored within the first lexicon:
determining, using the processing device, a first frequency of the term within the document corpus;
determining, using the processing device, a second frequency of the term within a comparison document corpus comprising a plurality of comparison documents, wherein the comparison document corpus is different from the document corpus;
determining, using the processing device, a difference between the first frequency and the second frequency;
comparing, using the at least one processing device, the difference between the first frequency and the second frequency to a comparison metric; and
when the difference between the first frequency and the second frequency satisfies the comparison metric, storing the term as a concept within a second lexicon stored in a non-transitory computer readable medium.

2. The computer implemented method of claim 1, wherein:
the comparison metric is a threshold; and
the comparison metric is satisfied when the difference between the first frequency and the second frequency is greater than the threshold.

3. The computer implemented method of claim 1, wherein the plurality of documents within the document corpus is a plurality of legal documents such that the document corpus is a legal document corpus.

4. The computer implemented method of claim 3, wherein the plurality of comparison documents within the comparison document corpus is a plurality of news documents such that the comparison document corpus is a news article corpus.

5. The computer implemented method of claim 1, further comprising, for each term of the plurality of terms stored within the first lexicon:
calculating, using the processing device, at least one additional frequency of the term within at least one additional comparison document corpus comprising a plurality of additional comparison documents, wherein the at least one additional comparison document corpus is different from the document corpus and the comparison document corpus;
determining an average frequency of the second frequency and the at least one additional frequency;
calculating, using the processing device, a difference between the first frequency and the average frequency;
comparing the difference between the first frequency and the average frequency to the comparison metric;
when the difference between the first frequency and the average frequency satisfies the comparison metric, storing the term within the second lexicon.

6. The computer implemented method of claim 1, wherein each term of the first lexicon is determined by:
determining a corpus term from the plurality of documents of the document corpus;
generating a candidate term from the corpus term, wherein generating the candidate term comprises generating a linguistic variant of the corpus term;
generating a plurality of equivalent terms from the candidate term;
validating the plurality of equivalent terms by comparing the plurality of equivalent terms to frequency of occurrence of the candidate term;
linking each of the plurality of equivalent terms to the candidate term to create respective equivalent term pairs;
determining whether any of the equivalent term pairs are equivalent and, in response to determining that at least two of equivalent term pairs are equivalent, merging the equivalent term pairs to create a group of equivalent terms;
selecting a normalized term from the group of equivalent terms; and
storing the normalized term as the term within the first lexicon.

7. The computer implemented method of claim 1, further comprising, for each term stored within the second lexicon, generating at least one expanded term.

8. The computer implemented method of claim 1, further comprising, for each term stored as a concept within the second lexicon, associating the term with an individual concept type from a plurality of concept types.

9. The computer implemented method of claim 8, wherein the plurality of concept types comprises a legal principle, a procedural-based concept, and a fact-based concept.

10. A system for generating concepts from a document corpus comprising a plurality of documents, the method comprising:
at least one processing device; and
at least one non-transitory computer-readable medium storing computer readable instructions that, when executed by the at least one processing device, causes the at least one processing device to:
retrieve a plurality of terms within a first lexicon stored in the at least one non-transitory computer-readable medium; and
for individual terms of the plurality of terms stored within the first lexicon:
determine a first frequency of the term within the document corpus;
determine a second frequency of the term within a comparison document corpus comprising a plurality of comparison documents, wherein the comparison document corpus is different from the document corpus;
determine a difference between the first frequency and the second frequency;
compare the difference between the first frequency and the second frequency to a comparison metric; and
when the difference between the first frequency and the second frequency satisfies the comparison metric, store the term as a concept within a second lexicon stored in the at least one non-transitory computer-readable medium.

11. The system of claim 10, wherein:
the comparison metric is a threshold; and
the comparison metric is satisfied when the difference between the first frequency and the second frequency is greater than the threshold.

12. The system of claim 10, wherein the plurality of documents within the document corpus is a plurality of legal documents such that the document corpus is a legal document corpus.

13. The system of claim 12, wherein the plurality of comparison documents within the comparison document corpus is a plurality of news documents such that the comparison document corpus is a news article corpus.

14. The system of claim 10, wherein the computer readable instructions further cause the at least one processing device to, for each term of the plurality of terms stored within the first lexicon:
calculate, using the at least one processing device, at least one additional frequency of the term within at least one additional comparison document corpus comprising a plurality of additional comparison documents, wherein the at least one additional comparison document corpus is different from the document corpus and the comparison document corpus;
determine an average frequency of the second frequency and the at least one additional frequency;
calculate, using the at least one processing device, a difference between the first frequency and the average frequency;
compare, using the at least one processing device, the difference between the first frequency and the average frequency to the comparison metric;
when the difference between the first frequency and the average frequency satisfies the comparison metric, store the term within the second lexicon.

15. The system of claim 10, wherein each term of the first lexicon is determined by:
determining a corpus term from the plurality of documents of the document corpus;
generating a candidate term from the corpus term, wherein generating the candidate term comprises generating a linguistic variant of the corpus term;
generating a plurality of equivalent terms from the candidate term;
validating the plurality of equivalent terms by comparing the plurality of equivalent terms to frequency of occurrence of the candidate term;
linking each of the plurality of equivalent terms to the candidate term to create respective equivalent term pairs;
determining whether any of the equivalent term pairs are equivalent and, in response to determining that at least two of equivalent term pairs are equivalent, merging the equivalent term pairs to create a group of equivalent terms;
selecting a normalized term from the group of equivalent terms; and
storing the normalized term as the term within the first lexicon.

16. The system of claim 10, further comprising, for each term stored within the second lexicon, generating at least one expanded term.

17. The system of claim 10, further comprising, for each term stored as a concept within the second lexicon, associating the term with an individual concept type from a plurality of concept types.

18. The system of claim 17, wherein the plurality of concept types comprises a legal principle, a procedural-based concept, and a fact-based concept.

19. A computer implemented method for generating concepts from a document corpus comprising a plurality of documents, the method comprising:
retrieving, using a processing device, a plurality of terms stored within a first lexicon; and
for individual terms of the plurality of terms stored within the first lexicon:
determining, using the processing device, a subset of the plurality of documents, where each document with the subset of the plurality of documents has a body section that includes the term;
determining, using the processing device, a percentage of documents within the subset of the plurality of documents that has a headnotes section that includes the term;
comparing the percentage with a percentage threshold; and
when the percentage is greater than the percentage threshold, storing the term as a concept within a second lexicon stored in a non-transitory computer readable medium.

20. The computer implemented method of claim 19, further comprising, for each term stored within the second lexicon, associating the term with an individual concept type from a plurality of concept types.
